(19) United States
(12) Patent Application Publication
(10) Pub. No.: US 2020/0202304 A1
(43) Pub. Date: Jun. 25, 2020

(54) METHOD AND SYSTEM FOR JOB REPORTING TO THIRD PARTY

(71) Applicant: Michele Alexandria Maltese, Dearborn, MI (US)

(72) Inventor: Michele Alexandria Maltese, Dearborn, MI (US)

(21) Appl. No.: 16/720,914

(22) Filed: Dec. 19, 2019

Related U.S. Application Data
(60) Provisional application No. 62/782,709, filed on Dec. 20, 2018.

(51) Int. Cl. G06Q 10/10

(52) U.S. Cl. CPC G06Q 10/1053

(57) ABSTRACT

A system and method for reporting job information concerning a job carried out by a job applicant for an employer to a third party. The method includes: displaying a map view of a job applicant application on a visual display of a job applicant device of a job; receiving input indicating that the job applicant desires to be hired for a job; sending a job request message from the job applicant device to an employer device of an employer, wherein the job request message specifies job applicant information, and wherein the job applicant information includes a name of the job applicant; recording job performance information concerning the job, wherein the job performance information includes a job length; and sending one or more third party reporting messages to one or more third party devices, wherein the third party reporting messages include the job performance information and a job applicant identifier.

### CROSS-REFERENCES TO RELATED APPLICATIONS

This application claims priority in U.S. Provisional Patent Application Ser. No. 62/782,709 filed Dec. 20, 2018, which is incorporated herein in its entirety, by reference.

### TECHNICAL FIELD

This invention relates to methods and systems for recording information concerning a job performed by an individual for an employer and reporting job performance information concerning the job that was performed.

### BACKGROUND

Nowadays, computer technology has provided potential employees or job applicants to search job postings on websites for purposes of locating employment. Also, certain third parties seek information concerning jobs performed by certain individuals. In at least some instances, this information has to be compiled by the employee or job applicant and then submitted in paper form or otherwise to the third party. This compiling and reporting by the employee can become quite cumbersome when the employee takes on many one-time jobs often referred to as “gigs”.

### SUMMARY

In accordance with an aspect of the invention, there is provided a method for reporting job information concerning a job carried out by a job applicant for an employer to a third party. The method includes: displaying a map view of a job applicant application on a visual display of a job applicant device of a job applicant, wherein the map view includes one or more map images, a job applicant icon, and at least one available job icon, and wherein the job applicant icon and the at least one available job icon are displayed over at least one of the one or more map images; receiving input indicating that the job applicant desires to be hired for a job; sending a job request message from the job applicant device to an employer device of an employer, wherein the job request message specifies job applicant information, and wherein the job applicant information includes a name of the job applicant; recording job performance information concerning the job, wherein the job performance information includes a job length that specifies an amount of time that the job applicant took to perform the job; and sending one or more third party reporting messages to one or more third party devices, wherein each of the one or more third party reporting messages includes the job performance information and a job applicant identifier.

In various embodiments, the method may include any of the following features or any technically-feasible combination of two or more of these features:
the job applicant application enables the job applicant to select the one or more third parties, and wherein each of the one or more third party reporting messages are sent to one of the selected third parties;
at least one of the one or more third party reporting messages is automatically sent to one of the one or more third party devices in response to the job applicant device or the employer device receiving an indication that the job has been completed by the job applicant;
the job applicant application enables the job applicant to specify at least one of the one or more third party reporting messages to be automatically sent to one of the one or more third party devices in response to the job applicant device or the employer device receiving an indication that the job has been completed by the job applicant;
the method further comprises the steps of: selecting, using the job applicant device, at least one of the one or more third party reporting messages to be sent to at least one of the one or more third party devices; and receiving input at the job applicant device via a graphical button presented on a touchscreen of the job applicant device, wherein, in response to receiving the input at the job applicant device, the at least one selected third party reporting message is sent to the at least one third party device;
at least one of the one or more third party devices is a third party server that is located at a third party facility, and wherein the third party is an individual or entity that is separate and distinct from the job applicant and the employer;
permitting step includes sending the one or more third party reporting messages to the one or more third party devices;
the one or more third party reporting messages are sent from the job applicant device to the one or more third party devices; and/or
the one or more third party reporting messages are sent from the job applicant device to a server of a remote server system, wherein the one or more third parties are able to access information included in the one or more third party reporting messages through communication with the remote server system.

In accordance with another aspect of the invention, there is provided a method for reporting job information concerning a job carried out by a job applicant for an employer to a third party. The method includes: receiving job applicant information at a job applicant device from a job applicant, wherein the job applicant information is provided by the job applicant using one or more human-machine interfaces of the job applicant device, and wherein the job applicant information includes a name of the job applicant; displaying a map view of a job applicant application on a visual display of the job applicant device of the job applicant, wherein the map view includes one or more map images, a job applicant icon, and at least one available job icon, and wherein the job applicant icon and the at least one available job icon are displayed over at least one of the one or more map images; sending a job request message from the job applicant device to an employer device of an employer, wherein the job request message specifies at least part of the job applicant information, and wherein the at least part of the job applicant information includes the name of the job applicant; clocking the job applicant into the job using either or both of the job applicant device and the employer device; clocking the job applicant out of the job using either or both of the job applicant device and the employer device; recording job performance information concerning the job, wherein the job performance information includes a job length that specifies an amount of time that the job applicant took to perform the job; in response to clocking the job applicant out of the job, displaying a send third party reports screen on the visual display of the job applicant device using the job applicant application, wherein the send third party reports screen includes a third party reports list that has one or more selectable entries, each of which specifies either or both of: (i) a third party to which a third party reporting message is to be sent or (ii) a third party reporting message that is to be sent to a third party; during a time in which the job applicant application is displaying the send third party reports screen, receiving input from the job applicant; based on selection of the one or more selectable entries, determining one or more selected third party reporting messages to be sent; and in response to receiving the input from the job applicant, sending the one or more selected third party reporting messages to one or more third party devices, wherein each of the one or more selected third party reporting messages includes the job performance information and a job applicant identifier, and wherein the third party is an individual or entity that is separate and distinct from the job applicant and the employer.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a schematic depicting an embodiment of a job applicant device and illustrates some exemplary hardware and components of the job applicant device;

FIG. 3 depicts a front of the job applicant device of FIG. 2 where the device is depicted as front-facing;

FIG. 4 depicts a rear view of the job applicant device of FIG. 2 where the device is depicted as rear-facing;

FIG. 5 is a schematic depicting an embodiment of an employer device and illustrates some exemplary hardware and components of the employer device;

FIG. 6 is a block diagram depicting a front view of the employer device of FIG. 5 where the device is depicted as front-facing;

FIG. 7 is a block diagram depicting a rear view of the employer device of FIG. 5 where the device is depicted as rear-facing;

FIG. 8 is a flowchart depicting an embodiment of a method for reporting job information concerning a job carried out by a job applicant for an employer to a third party;

FIG. 9 illustrates an exemplary login screen that can be used as a part of the job applicant application executed by the job applicant device;

FIG. 10 illustrates an exemplary map view that can be used as a part of the job applicant application executed by the job applicant device;

FIG. 11 illustrates an exemplary job text search screen that can be used as a part of the job applicant application executed by the job applicant device;

FIG. 12 illustrates an exemplary job details screen that can be used as a part of the job applicant application executed by the job applicant device;

FIG. 13 illustrates an exemplary job listing screen that can be used as a part of the employer application executed by the employer device;

FIG. 14 illustrates an exemplary job detail screen that can be used as a part of the employer application executed by the employer device;

FIG. 15 illustrates an exemplary job applicant detail screen that can be used as a part of the employer application executed by the employer device;

FIG. 16 illustrates an exemplary third party reporting screen that can be used as a part of the job applicant application executed by the job applicant device;

FIG. 17 illustrates an exemplary send third party reports screen that can be used as a part of the job applicant application executed by the job applicant device;

FIG. 18 illustrates an exemplary job applicant settings screen that can be used as a part of the job applicant application executed by the job applicant device;

FIG. 19 illustrates an exemplary employer settings screen that can be used as a part of the employer application executed by the employer device;

FIG. 20 illustrates an exemplary edit employer or business screen that can be used as a part of the employer application executed by the employer device; and

FIG. 21 illustrates an exemplary create job posting screen that can be used as a part of the employer application executed by the employer device.

### DETAILED DESCRIPTION

The system and method described herein enables information concerning a job performed by an individual for an employer to be recorded and job performance information to be reported. As used herein, the term “job” means any one or more tasks that are to be performed, or that were performed, by an individual in consideration for money, for volunteering purposes, or for educational or training purposes. As used herein, the term “employer” means any individual or entity that offers a job, volunteering, or training opportunity to be completed by a job applicant. As used herein, the term “job applicant” means any individual that is seeking to be hired, employed, or selected for completing a job. As used herein, the term “third party” means any individual or entity that is not the job applicant or employer. According to at least some embodiments, the system and/or method discussed herein may be embodied in one or more computer applications that are executable by a job applicant device, which, as used herein, is an electronic device that has remote network capabilities (e.g., can connect to the internet) and that is personal to the job applicant—for example, the job applicant device may be a smartphone of the job applicant or may be a personal desktop computer of the job applicant.

The job applicant device includes a job applicant application that includes computer instructions for carrying out the functionality of the job applicant application discussed below. The job applicant uses their job applicant device (e.g., smartphone or desktop computer of the job applicant) to search and apply for job opportunities that are posted by an employer, such as through the use of an employer device (e.g., smartphone or desktop computer of the employer). The job applicant can use the job applicant application to find job opportunities and view information of the job opportunities, such as the time, location, and type of job. The job applicant can further apply for a particular job by providing input indicating the job applicant's desire in being hired for the particular job. In response to this input, the job applicant application then sends a message to a backend application server that then sends a message to the employer device, or the employer application, which may then inform the employer that the job applicant is interested or requests to be hired. The employer can then provide input confirming or denying the request from the job applicant, which can then be communicated back to the job applicant device, such as through a backend application server of a backend application server facility.

After it is agreed upon that a particular job applicant is to perform a job for the employer, job information, including job performance information, is compiled by the job applicant application and/or a backend application server facility. This job information can include job performance information and/or any information relating to the job. The job performance information is any information that concerns performance of the job, such as the number of hours that the job took, or is expected to take, the location where the job was, or is to be, performed, the date on which the job was, or is to be, performed, etc. The job information, including the job performance information, can be stored at the job applicant device, the employer device, and/or the backend application server facility. The job information can be sent to a third party device, such as a third party server or a third party personal device (e.g., smartphone or desktop computer of the third party).

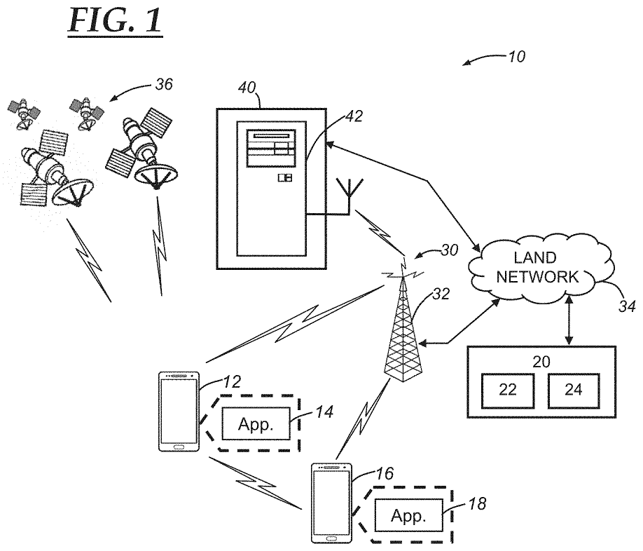

With reference to FIG. 1, there is shown an operating environment that comprises a communications system 10 and that can be used to implement the method disclosed herein. Communications system 10 generally includes a job applicant device 12 that includes a job applicant application 14, an employer device 16 that includes an employer application 18, a backend application server facility 20 having at least one backend application server 22 and at least one database 24, a wireless carrier system 30 having a cell tower 32, a land communications network 34, a constellation of global navigation satellite system (GNSS) satellites 36, and a third party facility 40 having at least one third party server 42. It should be understood that the disclosed method can be used with any number of different systems and is not specifically limited to the operating environment shown here. Moreover, the disclosed system of FIG. 1 is but one embodiment and those skilled in the art should appreciate that other embodiments of the system can include additional or different components, or may omit certain components shown in FIG. 1. Thus, the following paragraphs simply provide a brief overview of one such communications system 10; however, other systems not shown here could employ the disclosed method as well.

The job applicant device 12 and the employer device 16 are each depicted as a smartphone in the illustrated embodiment. However, it should be appreciated that many other types of electronic devices can be used for either of these devices, such as a desktop computer, a laptop, a tablet, a wearable electronic device (e.g., smartwatch, smart-glasses/goggles), etc. The job applicant device 12 includes the job applicant application 14, which is a computer application having computer instructions, and the employer device 16 includes the employer application 18, which is also a computer application having computer instructions.

The job applicant device 12 and the employer device 16 are each connected to at least one of the backend application servers 22 via the wireless carrier system 30 and the land network 34. In other embodiments, the job applicant device 12 and/or the employer device 16 are each connected to at least one of the backend application servers 22 via a different type of remote network connection. For example, in an embodiment where the job applicant device 12 is a desktop computer, the job applicant device 12 may connect to the backend application servers 22 via a wired connection through the land network 34 and without use of the wireless carrier system 30.

The wireless carrier system 30 may be any suitable cellular telephone system. The wireless carrier system 30 is shown as including a cellular tower 32; however, the carrier system 30 may include one or more of the following components (e.g., depending on the cellular technology): cellular towers, base transceiver stations, mobile switching centers, base station controllers, evolved nodes (e.g., eNodeBs), mobility management entities (MIMEs), serving and PGN gateways, etc., as well as any other networking components that may be needed to connect wireless carrier system 30 with the land network 34 or to connect the wireless carrier system with user equipment (UEs, e.g., which can include the job applicant device 12 and/or the employer device 16 when such devices are smartphones or other cellular-enabled devices). The wireless carrier system 30 can implement any suitable communications technology, including GSM/GPRS technology, CDMA or CDMA2000 technology, LTE technology, etc. In some embodiments, the wireless carrier system 30 may be embodied in the form of satellite communication hardware that can be used to provide bi-directional communication with a cellular device (e.g., the job applicant device 12 and/or the employer device 16). This can be done using one or more communication satellites (not shown) and an uplink transmitting station (not shown)

Land network 34 may be a conventional land-based telecommunications network that is connected to one or more landline telephones and connects wireless carrier system 30 to the backend application server facility 20, the third party facility 40, the job applicant device 12, the employer device 16, and/or other remote network enabled device. For example, the land network 34 may include a public switched telephone network (PSTN) such as that used to provide hardwired telephony, packet-switched data communications, and the Internet infrastructure. One or more segments of land network 34 could be implemented through the use of a standard wired network, a fiber or other optical network, a cable network, power lines, other wireless networks such as wireless local area networks (WLANs), networks providing broadband wireless access (BWA), or any combination thereof.

The backend application server facility 20 is a remote facility, meaning that it is located at a physical location that is located remotely from the job applicant device 12 and the employer device 16. The backend application server facility 20 includes a remote server system, which is a system that includes one or more servers that are located at a remote facility. The backend application server facility 20 includes at least one backend application server 22 that is connected to the job applicant device 12 and the employer device 16 via a remote communication connection, which can be provided via the Internet. The backend application servers 22 are each an electronic computer that provide support or assist with the functionality of the job applicant device 12 and/or the employer device. Those skilled in the art will appreciate that, although only one backend application server facility 20 and one backend application server 22 are depicted in the illustrated embodiment, numerous backend application server facilities 20 and/or servers 22 may be used. Also, in some embodiments, the job applicant application 14 may be provided backend server support by a first backend application server and the employer application 18 may be provided backend server support by a separate, second backend application server. In such a case, the first backend application server and the second backend application server can be co-located located at the same location) or may be part of separate backend application server facilities. Also, in such cases, the first backend application server can communicate with the second backend application server via any suitable remote network connection, including those described herein.

The backend application server facility 20 (or “backend facility 20” for short) may be designed to provide the job applicant application 14 and/or the employer application 18 with a number of different system backend functions through use of the backend application servers 22. The backend application server facility 20 can also include one or more backend application databases 24, which may be stored on a plurality of memory devices. The backend application server facility 20 may receive and transmit data via a modem connected to land network 34. Data transmissions may also be conducted by wireless systems, such as IEEE 802.11x, GPRS, and the like.

Each of the backend application servers 22 can be a computer that includes at least one processor and memory. Although the term “server” is used to refer to those electronic computers 22 used at the backend application server facility 20, it should be appreciated that this term is not intended on limiting the type of hardware or configuration of these devices, but is instead used to describe any device that is capable of carrying out the backend functionality of servers 22 discussed below that is, other types of devices, such as those that are termed “computers,” “cloud devices,” “computing devices,” or the like can be used as the backend application servers 22 to the extent such devices carry out the functionality of said servers 22 discussed herein. The processors can be any type of device capable of processing electronic instructions including microprocessors, microcontrollers, host processors, controllers, and application specific integrated circuits (ASICs). The processors can be dedicated processors used only for servers 22 or can be shared with other systems. The at least one processor can execute various types of digitally-stored instructions, such as software or firmware, which enable the servers 22 to provide those backend services discussed herein. For network communications (e.g., intra-network communications, inter-network communications including Internet connections), the servers 22 can include (or be connected to) one or more network interface cards (NICs) (including, for example, wireless NICs (WNICs) that can be used to transport data to and from the computers. These NICs can allow the one or more servers 22 to connect with one another, databases 24, or other networking devices, including routers, moderns, and/or switches. In one particular embodiment, the NICs (including WNICs) of servers 22 may allow SRWC connections to be established and/or may include Ethernet (IEEE 802.3) ports to which Ethernet cables may be connected to that can provide for a data connection between two or more devices. The backend application server facility 20 can include a number of routers, modems, switches, or other network devices that can be used to provide networking capabilities, such as connecting with land network 34 and/or cellular carrier system 30.

The backend application databases 24 referred to as databases 24 can be stored on a plurality of memory, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and/or magnetic or optical disc drives. The one or more databases 24 at the backend application server facility 20 can store various information and can include job information, employer information, job applicant information, etc.

The third party facility 40 includes the at least one third party server 42, which is an example of a third party device. The third party server is a server or computer that allows a third party to access job information concerning one or more job applicants. Each of the at least one third party server 42 is a server or computer that is owned or controlled by a third party, which is an individual or entity that is not the job applicant and not the employer. An example of a third party is a state government or municipality for example, in certain instances, a state government may require certain individuals to report information concerning their employment or the performance of jobs carried out by that individual. For example, in Michigan, a food assistance program that assists individuals with paying for food or other requisite items can be provided to certain individuals that meet certain requirements. As a part of continuing to receive the benefits of this food assistance program, the state of Michigan requires proof that the individual meets certain employment conditions, such as a minimum number of hours worked per week. The third party device (which is discussed as the third party servers 42) enables the third party to access job information of a particular job applicant. In other embodiments, the third party device enables the third party to access job information of a particular employer either in addition to or in lieu of a particular job applicant.

The third party servers 42 may be accessed by the third party using a third party application, which is an application that enables job information to be presented to the third party via a human-machine interface (HMI). In one embodiment, the third party servers 42 are connected to a third party personal device (e.g., smartphone of a third party), which is a third party device that is separate from the third party server. The third party personal device can then access the information, such as job performance information or other job information, stored at the third party server (i.e., information accessible by the third party server, such as information that is stored on a database accessible by the third party server). In another embodiment, the system 10 does not include a third party facility or a third party server, but instead includes a third party device that is provided with job information or that is at least provided with access to the job information; for example, the third party device may be a smartphone used by an agent of the third party, where the smartphone is permitted access to certain job information stored at the backend application databases 24. Or, as another example, the third party device may be a desktop computer used by an agent of the third party, where certain job information is sent from the backend application servers 22 to the desktop computer of the third party agent.

Each of the third party devices, third party servers, and the backend application servers 22 include or are in communication with a processor and memory. Also, each of these devices includes long-range communication hardware that enables the device to carry out long-range or remote network communications; examples of long-range communication hardware include a cellular chipset (such as those of devices 12, 16 discussed below) or a modern. Various types of processors and memory can be used for each of the third party devices, third party servers, and the backend application servers 22, such as those types of processors and memory discussed below with respect to the devices 12, 16. Also, each of the third party devices, third party servers, and the backend application servers 22 can include one or more human-machine interfaces (HMIs), such as one or more displays, pushbuttons, microphones, and/or speakers. Various other HMIs can also be utilized, as the interfaces discussed above are only examples.

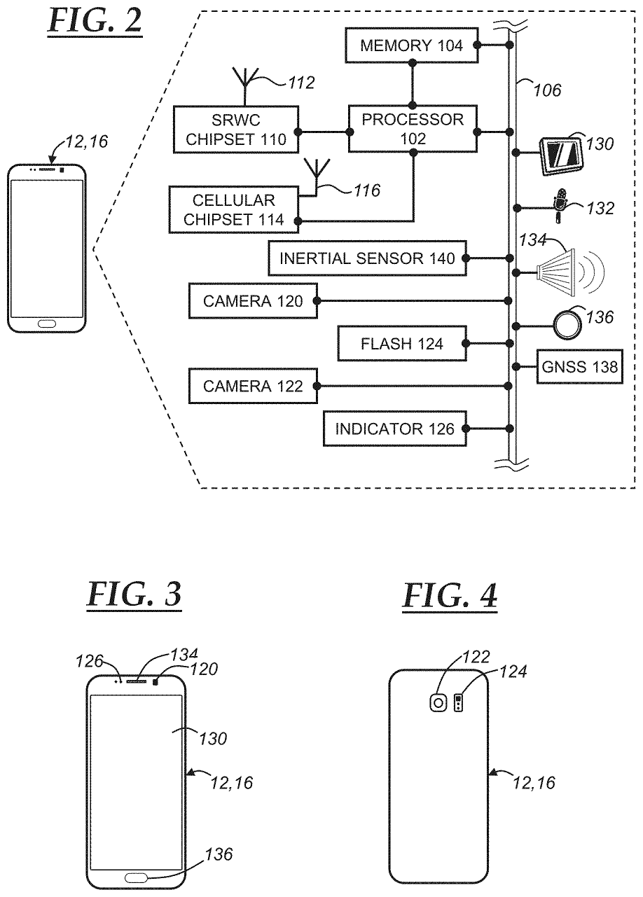

In the illustrated embodiment, with reference to FIGS. 2-7, the job applicant device 12 and the employer device 16 are each a portable wireless device (PWD) and, more particularly, a smartphone. As used herein, a portable wireless device (PWD) is a device that is capable of network communications and that is portable by a user, such as a wearable device (e.g., a smartwatch), an implantable device, or a handheld device (e.g., a smartphone, a tablet, a laptop). The job applicant device 12 and the employer device 16 are each shown as a smartphone having cellular telephone capabilities; however, in other embodiments, each of the job applicant device 12 or the employer device 16 may be a tablet, a wearable electronic device (e.g., a smartwatch or an electronic ocular device), other PWD, or any other suitable electronic computer.

With specific reference to FIGS. 2-4, the job applicant device 12 includes a processor 102, memory 104, communications bus 106, wireless chipsets/circuits 110,114, antennas 112,114, cameras 120,122, GNSS module 138, inertial sensors 140, a camera flash 124, an LED indicator 126, a display 130, a microphone 132, a speaker 134, and a pushbutton 136. The discussion below of the hardware components of the job applicant device 12 applies also to the employer device 16 and, for purposes of brevity, will not be repeated.

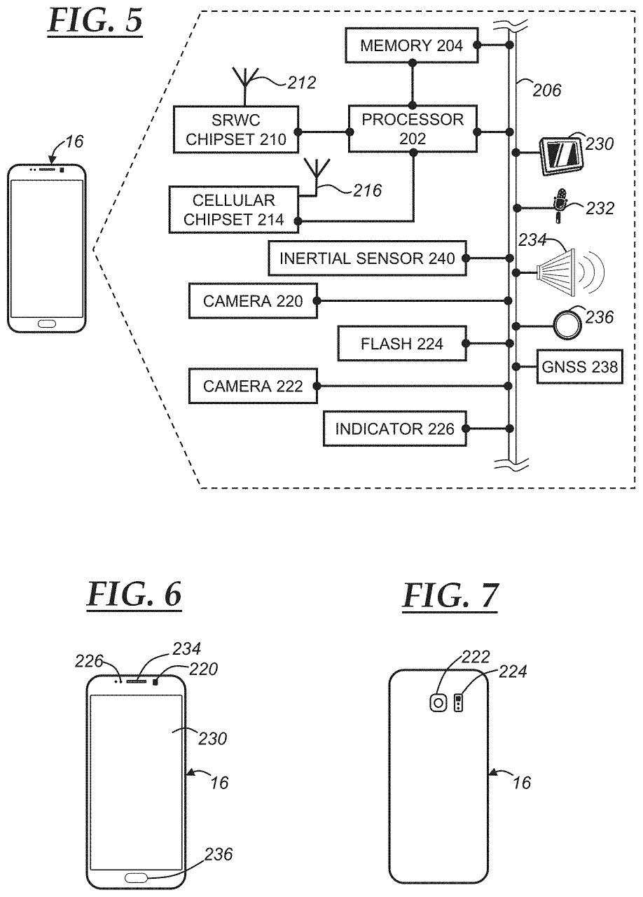

The processor 102 can be any type of device capable of processing electronic instructions and can execute such instructions that may be stored in memory 104, such as microprocessors, microcontrollers, host processors, controllers, and application specific integrated circuits (ASICs). For instance, the processor 102 can execute programs or process data to carry out at least a part of the method discussed herein. The processor may also execute an operating system for the job applicant device, such as Android™, iOS™, Microsoft™ Windows™, and/or other operating systems. The operating system may provide a user interface and a kernel, thereby acting as a central control hub that manages the interfacing between the hardware and software of the job applicant device. Moreover, the operating system may execute mobile applications, software programs, and/or other software or firmware instructions. The processor 102 executes the job applicant application 14, and the processor 202 (FIG. 5) of the employer device 16 executes the employer application 18.

Memory 104 may include a non-transitory computer-readable medium, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives. In other embodiments, memory 104 may be a non-volatile memory card, such as a Secure Digital™ (SD) card, that is inserted into a card slot of the job applicant device 12.

The processor 102 and/or memory 104 may be connected to a communications bus 106, which allows for the communication of data between the processor and other components of the job applicant device 12, such as cameras 120,122, camera flash 124, LED indicator 126, visual display 130, microphone 132, speaker 134, pushbutton 136, GNSS module 138, inertial sensors 140, and/or various other components. The processor 102 may provide processing power for such components and/or may, through the operating system, coordinate functionality of the components, while the memory 104 may allow for storage of data that may be usable by such components. For example, the processor may run the primary operating system for the job applicant device 12, which may include displaying a graphical user interface (GUI) on a touchscreen display 130. In such an example, the GUI may include the display of images that may be stored in memory 104. The PWD processor and software stored in the memory also enable various software applications, which may be preinstalled or installed by a user or by a manufacturer. This may include the job applicant application 14 that can allow the job applicant device 12 to carry out certain functionality discussed herein, which can include connecting with the backend application servers 22 and/or the employer device 16. It should be appreciated that the employer device 16 includes the employer application 18, which can allow the employer device 16 to carry out certain functionality discussed herein, which can include connecting with the backend application servers 22 and/or the job applicant device 12. The job applicant application 14 may use one or more of the components of the job applicant device 12, such as the display 130, the front-facing camera 120, the rear-facing camera 122, the GNSS module 138, the inertial sensors 140, and the speaker 134. Likewise, the employer application 18 may use one or more of the components of the employer device 16.

The job applicant device 12 includes a short range wireless communications (SRWC) chipset 110 and a SRWC antenna 112, which allows the device 12 to carry out SRWC, such as any of the IEEE 802.11 protocols, WiMAX™, ZigBee™, Wi-Fi direct™, Bluetooth™, or near field communication (NFC). The SRWC chipset may allow the job applicant device 12 to connect to another SRWC device, such as the employer device 16, for example.

Additionally, the job applicant device 12 includes a cellular chipset 114 thereby allowing the job applicant device 12 to communicate via one or more cellular protocols, such as GSM/GPRS technology, CDMA or CDMA2000 technology, and LTE technology. The job applicant device 12 may communicate data over wireless carrier system 30 using the chipset 114 and cellular antenna 116. Although the illustrated embodiment depicts a separate chipset and antenna for SRWC and cellular communications chipsets, in other embodiments, there may be a single antenna for both chipsets, a single chipset and multiple antennas, or both a single chipset and a single antenna. In such an embodiment, radio transmissions may be used to establish a communications channel, such as a voice channel and/or a data channel, with wireless carrier system 30 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Global Navigation Satellite System (GNSS) receiver 138 receives GNSS signals from a constellation of GNSS satellites 36 (FIG. 1). The GNSS receiver 138 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 138 may be a GPS receiver, which may receive GPS signals from a constellation of GPS satellites 36. And, in another example, GNSS receiver 138 can be a BDS receiver that receives a plurality of GNSS (or BDS) signals from a constellation of GNSS (or BDS) satellites 36. The GNSS receiver can determine a current location of the job applicant device 12 based on reception of a plurality of GNSS signals from the constellation of GNSS satellites 36. This job applicant device location information can then be communicated to the backend application server facility 20 (e.g., to one or more of the backend application servers 22 and/or databases 24), to the third party server facility 40 (e.g., to one or more of the third party servers 42), to another third party device, and/or to the employer device 16. The location of the job applicant device 12 (as indicated by the GNSS location) can enable a determination to be made as to whether the job applicant device 12 (and, thus, the job applicant) is at a particular location, such as a home or workplace of the employer, and/or as to whether the job applicant device 12 is co-located with the job location of a particular job that is to be (or that is being or was) carried out by the job applicant.

Cameras 120 and 122 may be digitals cameras that are incorporated into the job applicant device 12 and that enable the job applicant device 12 to digitally capture images and videos. As shown in FIG. 3, camera 120 may be a front-facing camera, meaning that the camera faces an area in front of the front-side of the job applicant device 12—the front side of the job applicant device 12 can be that side that includes the main or primary visual display, which is display 130 in the illustrated embodiment. Since an operator of a job applicant device 12 generally holds or positions the job applicant device 12 so that the visual display is in view, in such an arrangement, camera 120 may face the operator, thereby allowing the operator to capture images and video of the operator and/or behind and surrounding the operator. As shown in FIG. 4, camera 122 is a rear-facing camera, meaning that the camera faces an area away from the front side of the job applicant device 12. Thus, in such an arrangement of usual use of the job applicant device 12 as described above, the camera may capture images or video of an area in front of the operator. In another embodiment, multiple cameras may be located on the job applicant device 12 such that the cameras capture images or video of the same area or at least part of the same area.

In some embodiments, the images or video captured by the camera may be displayed on visual display 130 even when the user is not presently capturing images or recording videos to be stored, thereby allowing the user to view the area that is being captured by the camera on the display. The image or video (or data thereof) that is captured by the camera and immediately displayed on the display 130 can be referred to as live video data. Also, the job applicant device 12 may overlay or dispose certain graphical objects over the displayed camera feed to achieve an augmented reality (AR) video, as will be discussed more below. In addition, the cameras may each include a camera flash, such as camera flash 124 which is shown in FIG. 4 to be primarily for use with rear-facing camera 122; however, such camera flash 124 or other camera flashes (not shown) may be used for other purposes such as for providing light in dark or low-light environments or providing a warning or other indicator to gain the attention of nearby persons.

The job applicant device 12 also includes a number of human-machine interfaces that allow users of the job applicant device 12 to provide and/or receive information. Such examples of user-device interfaces include indicator 126, visual display (or touchscreen) 130, microphone 132, speaker 134, and pushbuttons 136. Indicator 126 may be one or more light indicators, such as light emitting diodes (LEDs), and, in some embodiments, may be located on a front-face of the job applicant device 12, as shown in FIG. 3. The indicator may be used for numerous purposes, such as to indicate to an operator of the job applicant device 12 that there is a new notification on the job applicant device 12. Visual display or touch screen 130 is, in many embodiments, a graphics display, such as a touch screen located on the front face of the job applicant device 12, as shown in FIG. 3, and can be used to provide a multitude of input and output functions, Microphone 132 provides audio input to the job applicant device 12 to enable the user to provide voice commands and/or carry out hands-free calling via the wireless carrier system 70. Speaker 134 provides audio output and the pushbuttons 136 (only one shown) allow manual user input to provide other data, response, or control input. Other pushbuttons may be located on the job applicant device 12, such as a lock button on the side of the job applicant device 12, up and down volume controls, camera buttons, etc. Additionally, as those skilled in the art will appreciate, the pushbuttons do not need to be dedicated to a single functionality of the job applicant device 12, but may be used to provide interfacing means for a variety of different functionality. Various other human-machine interfaces (HMIs) can also be used, as the HMIs of FIGS. 2-4 are only an example of one particular implementation.

The inertial sensors 140 can be used to obtain sensor information concerning the magnitude and direction of acceleration of the job applicant device 12 as well as angular information concerning the orientation of the job applicant device 12. The inertial sensors can be microelectromechanical systems (MES) sensors, accelerometers, or gyroscopes that obtains inertial information, which can be (or be used to obtain) position information. The inertial sensors 140 can be used to determine or obtain orientation information concerning the job applicant device 12 and/or movement information concerning the job applicant device 12. The orientation information is information that represents an orientation of the job applicant device 12 with respect to a reference point or plane, such as the earth. The movement information is information that represents movement of the job applicant device 12. The movement information, the orientation information, and the live video data or other captured image/video data can be used to track the location of various objects within the field of view of the cameras 120,122.

With reference to FIGS. 5-7, the employer device 16 includes a processor 202, memory 204, communications bus 206, wireless chipsets/circuits 210,214, antennas 212,214, cameras 220,222, GNSS module 238, inertial sensors 240, a camera flash 224, an LED indicator 226, a display 230, a microphone 232, a speaker 234, and a pushbutton 236. It should be appreciated that the discussion above of the components of the job applicant device 12 apply equally to those like components of the employer device 16 (e.g., memory 204 of the employer device 16 is a like component of the memory 104 of the job applicant device 12) to the extent such discussion is not inconsistent with the explicit discussion of the employer device 16 provided herein.

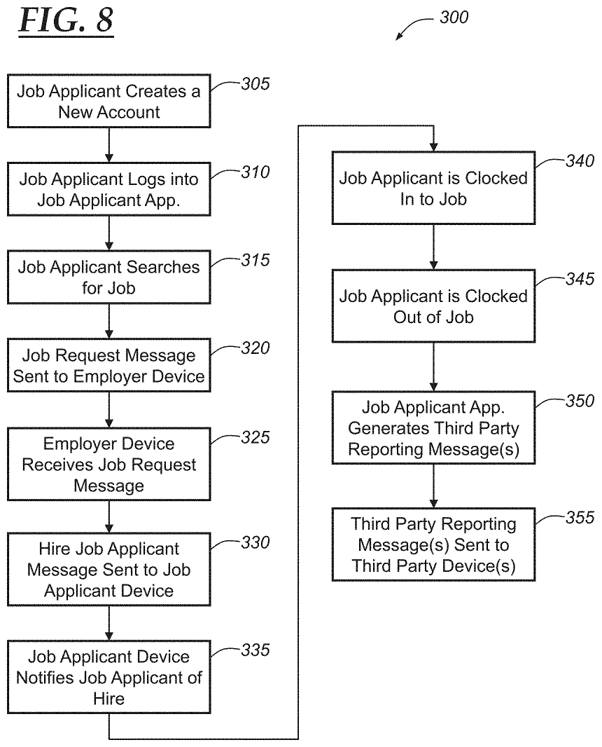

With reference to FIG. 8, there is shown an embodiment of a method 300 of reporting job information concerning a job carried out by a job applicant for an employer to a third party. In one embodiment, one or more steps of the method 300 is carried out by a job application device, such as the job applicant device 12 discussed above. And, in some embodiments, one or more steps of the method 300 is carried out by the employer device 16. Although the steps of the method 300 are described as being carried out in a particular order, it is hereby contemplated that the steps of the method 300 can be carried out in any suitable order as will be appreciated by one in light of the knowledge of this disclosure.

The method 300 begins with step 305, wherein a job applicant creates a new account for use with the job applicant application. In one embodiment, to create a new account, the job applicant can use the job applicant device to input (e.g., using an onscreen keyboard of the job applicant device 12) job applicant information. The job applicant information can include personal information concerning the job applicant, such as a name of the job applicant, a home location, or other specified location, of the job applicant, an employment status of the job applicant, a birthdate or age of the job applicant, and job applicant resume information (or a link to job resume information). The job applicant information can also include job search information, which is information concerning jobs that the job applicant is interested in. For example, the job search information can include one or more specific types of jobs (e.g., leaf pickup, food delivery), one or more job industries (e.g., landscaping, delivery services), job permanence information (e.g., fill-time, part-time, one-time job), and job location information (e.g., maximum job distance from the home location (or other predetermined location) of the job applicant, one or more particular municipalities or states). In one embodiment, the job applicant can also specify a default job schedule, which can be a recurring schedule that indicates one or more time periods in which the job applicant is typically available and/or willing to perform a job.

In one embodiment, the job applicant can also specify whether the job applicant's account is to be public or private. A public job applicant account is an account of a job applicant that is visible by any employer using the employer application. A private job applicant account is an account of a job applicant that is not visible to any employer until the job applicant applies for a particular job of an employer and, at that time, the employer of the job that the job applicant applied for then is able to view the job applicant's account. In one embodiment, the job applicant can also specify or set job reporting settings, which are settings or preferences related to reporting of job performance by the job applicant to a third party. The job reporting settings can be configured by the job applicant to indicate whether job performance information (and/or other job information) of the job applicant should be reported to one or more third parties, such as a state department (of the state government). For example, upon completion of a job, which will be discussed more below, the job applicant application can then prompt the job applicant to select one or more third parties to which job performance information is to be sent. Additionally or alternatively, the job reporting settings can also specify whether job performance information (and/or other job information) is to be automatically reported to one or more third parties upon completion of the job. For example, upon completion of a job, the job applicant application can then automatically send job performance information to one or more third parties that were specified by the job applicant in the job reporting settings. The job applicant can also input job applicant credentials to be used to access their account. For example, the job applicant credentials can include a username and a password. The username can be an email or a unique string of alphanumeric (and/or other) characters. The password can be a string of alphanumeric and/or other characters. All of the information discussed above in this step can be saved to the job applicant device 12 and/or sent to the backend application server facility 20 and stored in memory at the backend application server facility 20, such as in one or more databases 24. Once an account is created, the method 300 continues to step 310.

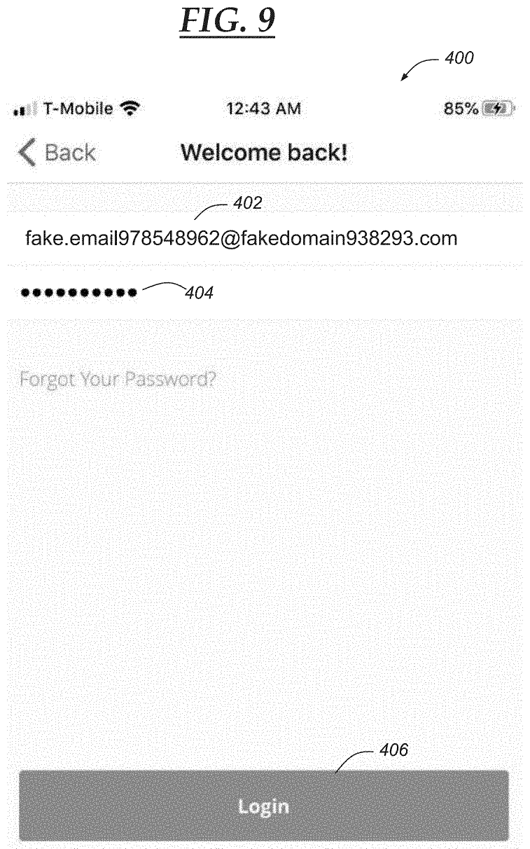

In step 310, the job applicant logs into the job applicant application using the job applicant credentials. The job applicant can use any of a number of HMIs to input the job applicant credentials. For example, the job applicant can use the job applicant device 12 to input the job applicant credentials using an onscreen keyboard of the job applicant device 12. With reference to FIG. 9, there is shown an exemplary login screen 400 that can be used as a part of the job applicant application 14. The job applicant can input their username (as shown at 402) and their password (as shown at 404). The job applicant can then select the onscreen login button 406. In one embodiment, in response to selecting the login button 406, the job applicant credentials (as entered by the job applicant at 402 and 404) are sent to the backend application servers 22, which can then verify whether the entered job applicant credentials match the job applicant credentials of the job applicant. Once the entered job applicant credentials are verified to be correct, the job applicant is permitted access to the associated job applicant account. The method 300 continues to step 315.

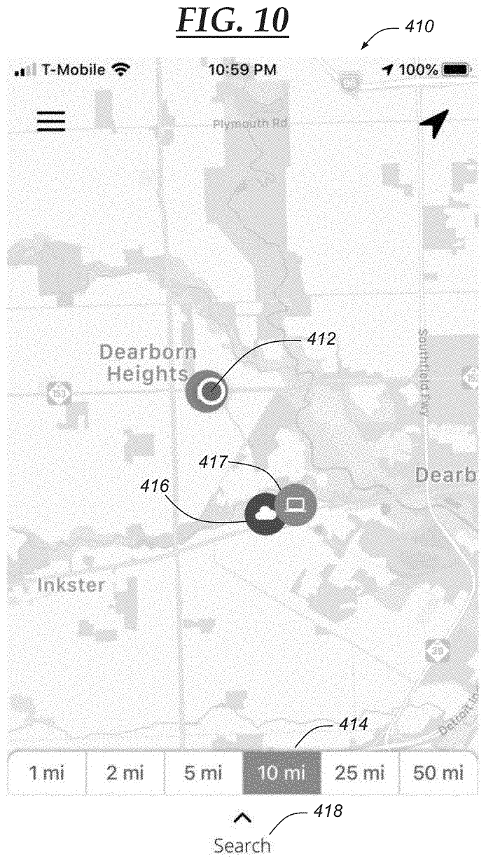

In step 315, the job applicant searches for a job being offered by an employer. In one embodiment, the job applicant uses a map searching feature of the job applicant application 14 to search for a job. For example, as shown in FIG. 10, the job applicant application 14 displays a map view 410 in which the current location of the job applicant is indicated by icon 412. In one embodiment, when the job applicant first enters or opens the map view 410, the map can be centered around the current location of the job applicant. In other embodiments, the map view 410 may be initially centered around a location that is specified by the job applicant, such as a home location of the job applicant. The map view 410 displays an available job icon for each job being offered by an employer. For example, as shown in FIG. 10, there are two available jobs as indicated by icons 416 and 417. The job applicant may also select one or more filters to be applied to the surrounding jobs so that the available jobs are filtered based on the selected filters. The job filters may be specified as a part of the job applicant's general settings (such as those discussed above in step 305) and/or may be specified at the time of searching for a job, such as when using the map view 410. For example, as shown in FIG. 10, the job applicant can specify a maximum job distance as shown at 414, which is currently set at 10 miles; thus, in such an example, the job applicant application filters the jobs so that only jobs within 10 miles of the current location (or other specified location) of the job applicant are display on the map view 410.

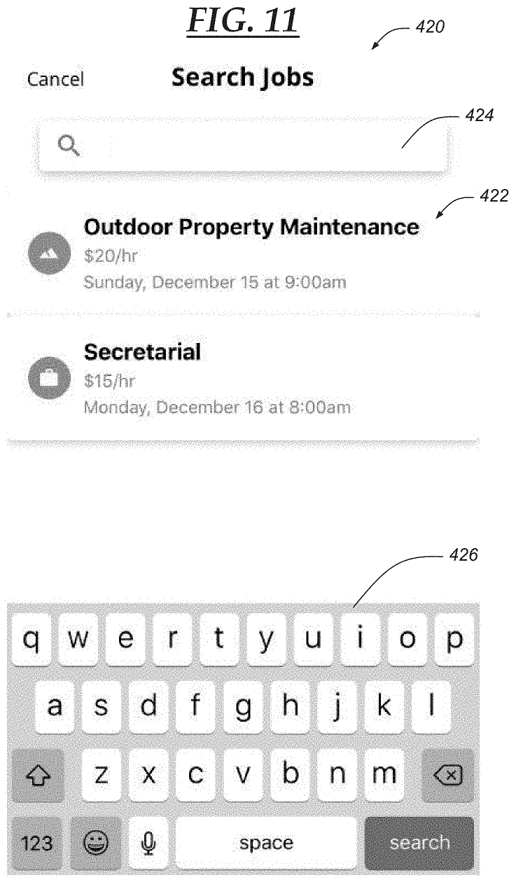

Additionally or alternatively, the job applicant can search for a job using a query. For example, the job applicant can select the “Search” button 418, which then causes the job applicant application to display the job text search screen 420, as shown in FIG. 11. The job text search screen 420 displays jobs that are available to the user in a list, as shown at 422. The job applicant can use the onscreen keyboard 426 to enter text into the search input 424, which, when entered, filters the job list 422.

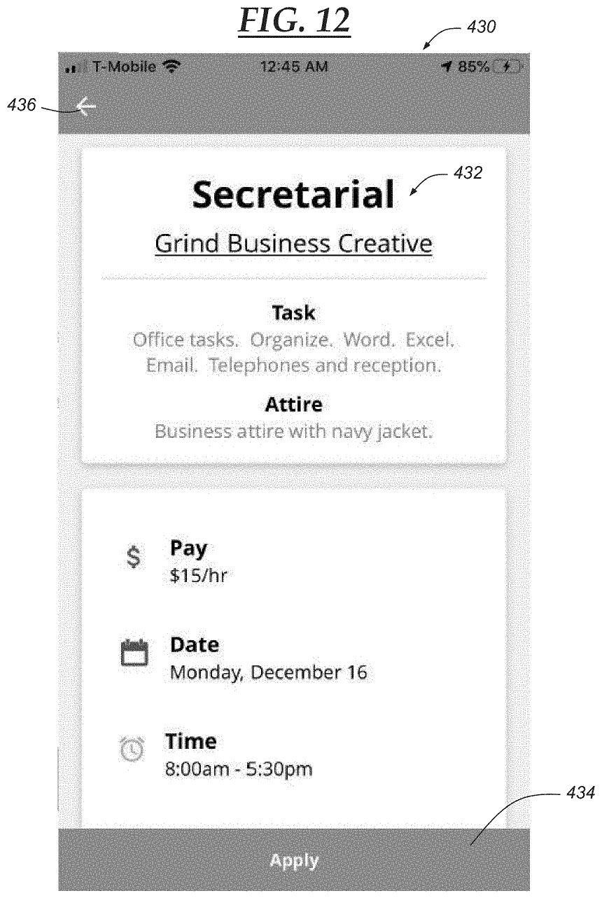

Through use of the map view or the job text search screen, the job applicant can select on a job to view more details concerning that job. For example, as shown in FIG. 12, the job applicant application 14 displays a job details screen 430 that includes a job details portion 432 showing details concerning the job, including the job title, the employer name, one or more job tasks, the job attire, the time and date of employment, and the job pay. The job details screen 430 also includes an apply button 434 and a back button 436. The back button 436, when clicked to selected, returns the job applicant to the previous screen. The method 300 continues to step 320.

In step 320, a job request message is sent from the job applicant device to an employer device. The job request message is sent in response to the job applicant device receiving an indication that the job applicant wants to apply to a particular job. This indication can be, for example, the job applicant selecting the apply button 434 on the job details screen 430 (FIG. 12). The job request message includes job applicant information (i.e., information concerning the job applicant), which can include personal information (e.g., name, age), a rating of the job applicant, job applicant resume information, and/or a link to job applicant resume information (e.g., a link to the job applicant's LinkedIn™ profile).

The job request message can be sent to the employer device in a number of ways. For example, in one embodiment, the job request message is sent directly from the job applicant device 12 to the employer device 16 without first being sent to the backend application server facility 20, such as via transmitting one or more SRWC messages. In another embodiment, the job request message is sent from the job applicant device 12 to the backend application server facility 20 and then from the backend application server facility 20 to the employer device 16. It should be appreciated that the job request message sent from the job applicant device 12 does not need to include all of the same information or he formatted in the same manner as the job request message received by the employer device 16, although it includes at least some of the same job applicant information (e.g., job applicant name, job applicant resume). The method 300 continues to step 325.

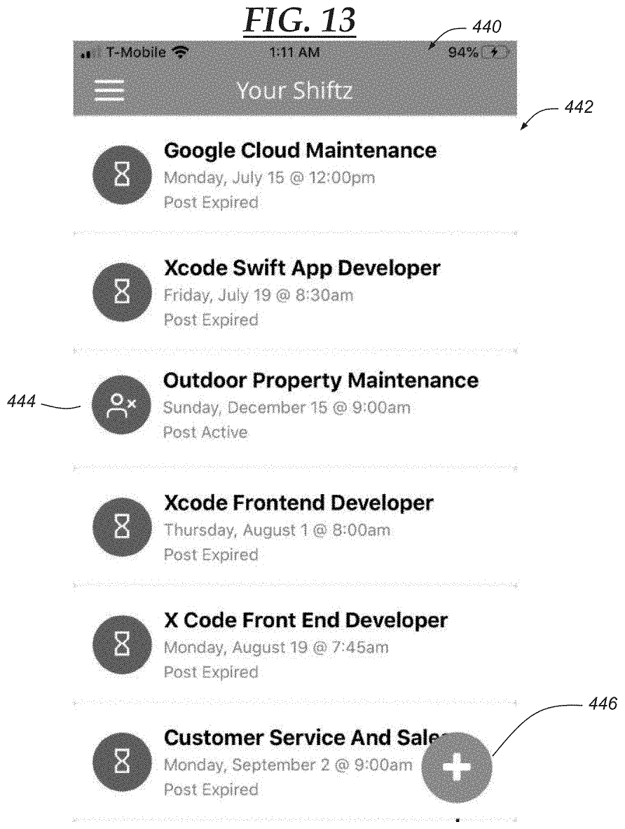

In step 325, the employer device receives the job request message. In one embodiment, in response to receiving the job request message, the employer device 16 notifies the employer through one or more suitable HMIs, such as through the LED indicator 226, the speaker 234, and/or the display 230. The employer can then log into the employer application 18, and can then view their job listings. For example, with reference to FIG. 13, the employer can use the employer application 18 to navigate to a job listing screen 440 that displays their job listings 442. The job listing screen 440 includes an add job button 446 that will allow the employer to add another job listing. When the employer selects the job item 444 from the job listings 442, the employer application 18 displays a job detail screen that provides details concerning the job associated with the selected job item 444.

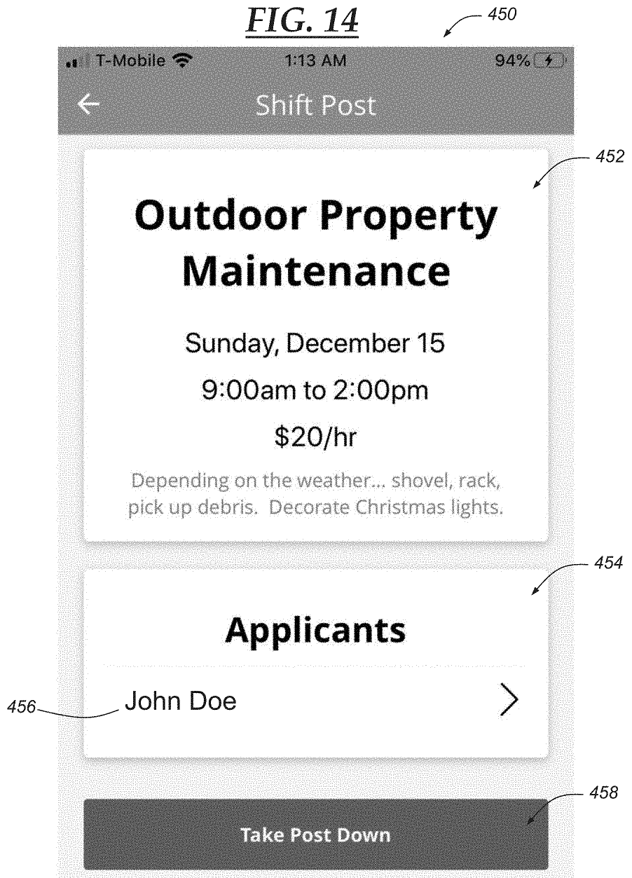

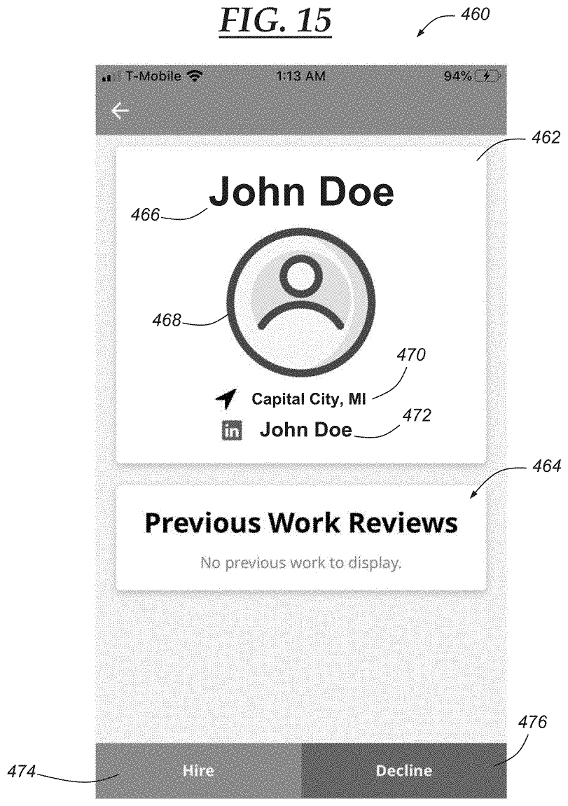

For example, with reference to FIG. 14, there is shown job detail screen 450 that includes job details 452 and a job applicant list 454 that have applied to the job. For example, in one embodiment, in response to the employer device (or employer application) receiving the job request message, the employer application can place job applicant information (e.g., job applicant's name) into the job applicant list 454. The job detail screen 450 also includes a button 458 that enables the employer to take down the job posting. The job applicant “John Doe” is listed in the job applicant list 454 as shown at 456. When the employer selects on a particular job applicant, such as “John Doe,” the employer application 28 then displays a job applicant detail screen 60. FIG. 15 depicts an exemplary job applicant detail screen 460 that shows job applicant information 462 and previous work reviews of the job applicant as shown at 464. The job applicant information 462 includes a job applicant name 466, a job applicant icon or logo 468, a job applicant location 470, and job applicant resume information link 472 that, when selected, opens the job applicant's LinkedIn™ profile (or other profile of the job applicant as provided by a third party system via an internet browser or third party mobile application, for example). The job applicant icon or logo 468 can be set by the job applicant using the job applicant application 14. For example, the job applicant can select an image or graphic from the storage on their smartphone (or job applicant device 12) or may select the image or graphic from a remote device, such as from an http URL.

The job applicant detail screen 460 also includes a hire job applicant button 474 and a decline job applicant button 476. The hire job applicant button 474, when selected, causes the employer application 18 to generate a hire job applicant message. Likewise, the decline job applicant button 476, when selected, causes the employer application 18 to generate a decline job applicant message. The hire job applicant message includes an indication that the job applicant (e.g., “John Doe”) is to be hired for the job. The decline job applicant message includes an indication that the job applicant (e.g., “John Doe”) is not to be hired for the job. In the case that the employer selects the decline job applicant button 476, the decline job applicant message will be generated by the employer device 16 and then sent to the job application device 12. The decline job applicant message can be sent directly to the job applicant device 12 (i.e., without first going to the backend application server facility 20) or may be sent to the job applicant device 12 via the backend application server facility 20. It should be appreciated that the decline job applicant message sent from the employer device 16 does not need to include all of the same information or be formatted in the same manner as the decline job applicant message received by the job applicant device 12, although it includes at least an indication that the job applicant is not to be hired for the job. In the case that the employer selects the hire job applicant button, the method 300 proceeds to step 330.

In step 330, the hire job applicant message is sent from the employer device to the job applicant device. In one embodiment, in the case that the employer selects the hire job applicant button 474, the hire job applicant message will be generated by the employer device 16 and then sent to the job application device 12. The hire job applicant message can be sent directly to the job applicant device 12 (i.e., without first going to the backend application server facility 20) or may be sent to the job applicant device 12 via the backend application server facility 20. It should be appreciated that the hire job applicant message sent from the employer device 16 does not need to include all of the same information or be formatted in the same manner as the hire job applicant message received by the job applicant device 12, although it includes at least an indication that the job applicant is to be hired for the job. The method 300 continues to step 335.

In step 335, the job applicant device notifies the job applicant that the job applicant is hired for the job. For example, the job applicant device 12 can use the LED indicator 126, the speaker 134, and/or the display 130 for notifying the user. In other embodiments, other suitable HMIs at (or controllable by) the job applicant device 12 can be used to notify the job applicant. The method 300 then continues to step 340.

In step 340, the job applicant clocks in at the beginning of the job (or clocks in thereby demarcating the beginning of the job). In one embodiment, the job applicant application includes a screen that allows an individual to input a code, such as a numeric pin or an alphanumeric password. For example, in response to selecting the hire job applicant button, the employer application 18 can generate a code and present the code to the employer via the employer device 16, such as through a graphical user interface (GUI). Then, at the start of the job or once the employer confirms the job applicant is to begin the job, the employer can enter the code into the job applicant application 14 of the job applicant device 12, which then can start the job performance period, which is a period of time in which the job is performed. Thus, upon entering the code, the job applicant is considered to have clocked into the job and, in many embodiments, the job start time is recorded at the job applicant device 12. This time (and/or other information, such as the job applicant device's current location) can be sent to the backend application server facility 20 and/or the employer device 16. The method 300 continues to step 345.

In step 345, the job applicant clocks out at the end of the job (or clocks out thereby demarcating the end of the job). In one embodiment, the employer uses the employer application 18 to indicate the end of the job (or to clock out the job applicant). This can be carried out by the employer selecting a graphical button presented on a GUI of the employer device 16. In another embodiment, the employer can enter another (or the same) code into the job applicant's phone. This code may be generated by the employer application 18 and presented to the employer in response to the employer hiring the job applicant. In the case that the employer uses the employer application 18 to clock out the job applicant, then the employer device can send a message to the job applicant device 12 (either directly or via the backend application server facility 20) that notifies the job applicant that the job has ended (or that the job applicant has been clocked out). The method 300 then continues to step 350.

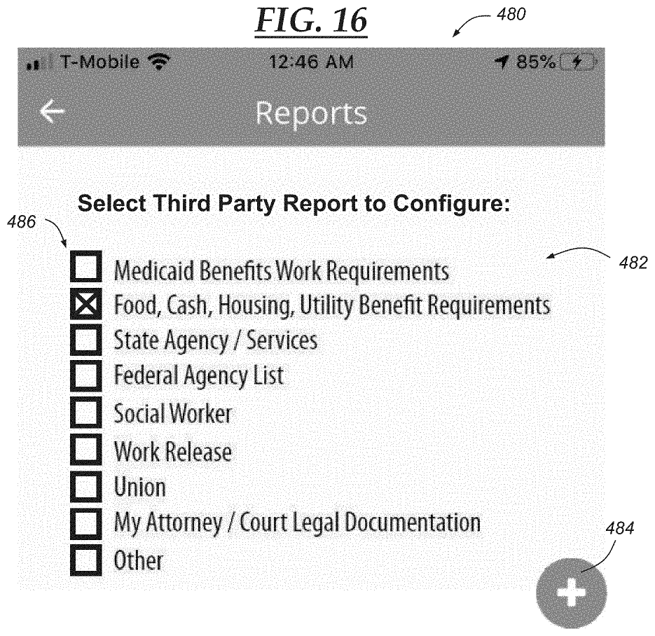

In step 350, the job applicant application generates one or more third party reporting messages that are to be sent to a third party. A third party reporting message is an electronic message that includes job information concerning a job performed by the job applicant. In many embodiments, the job information includes job performance information and personal information of the job applicant, such as the job applicant's name. In one embodiment, the job applicant can specify one or more third parties to which a third party reporting message will be sent. For example, as shown in FIG. 16, there is shown a third party reporting screen 480 that lists one or more third party reports in the third party reports list 482. The job applicant can add new third parties or third party reports by selecting the add third party report button 484. The job applicant can also edit settings or details of an existing third party report by clicking on the text (e.g., “Medicaid Benefits Work Requirements”) of the third party report in the third party reports list 482. The settings or details of the third party report can include a third party computer address (e.g., a URL), a third party account username (a username of a third party agent or account), a job applicant third party system username (i.e., a username of an account held by the job applicant for a third party system, such as for a third party web application account), an automatic reporting feature, or other features concerning the reporting of job applicant information or job performance information. The automatic reporting feature causes job information to be automatically sent in a third party reporting message to one or more specified third parties (or third party devices). Also, for example, the third party reporting screen 480 can include checkboxes 486 that, when checked, enable the automatic reporting feature for the associated third party report. In the example shown in FIG. 16, the “Food, Cash, Housing, Utility Benefit Requirements” checkbox is checked and, thus, at the completion of a job (e.g., in response to step 345), a third party report is sent to the third party handling the “Food, Cash, Housing, Utility Benefit Requirements”.

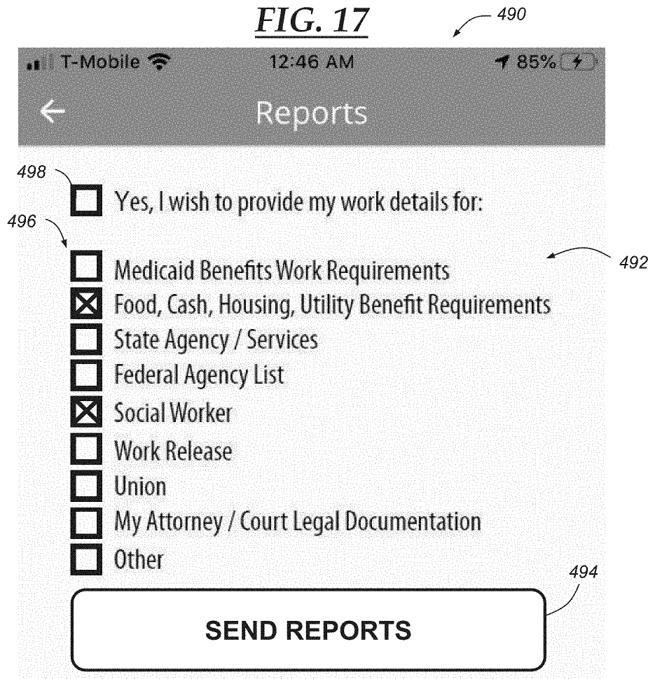

In some embodiments, the job applicant can navigate the job applicant application 14 to a send third party reports screen. The send third party reports screen can enable the job applicant to select one or more third parties (or third party reports). With reference to FIG. 17, there is shown an exemplary send third party reports screen 490, which includes a third party reports list 492, a send reports button 494, checkboxes 496 for selecting the third party report (or third party), and a select all button 498. The job applicant can select one or more of the checkboxes 496. The job applicant can select all of the checkboxes 496 by selecting the select all button 498. Then, the job applicant can select the send reports button 494, which then causes one or more third party reporting messages to be generated and/or sent. This send third party reports screen 490 can be used to send a third party report to the third party when the job applicant desires not to have the third party report be automatically sent after the job is completed.

The contents of the third party reporting message can vary depending on what information the job applicant wants to report and/or what information the third party would like to receive. However, in many embodiments, the third party reporting message includes a job applicant identifier. The job applicant identifier is any information that identifies the job applicant. This can be, for example, a legal name of the job applicant and/or a state-issued identifier (e.g., driver's license number, social security number) of the job applicant. In many embodiments, the third party reporting message includes job performance information concerning one or more jobs of the job applicant. The job performance information can include, for example, a job identifier (a unique identifier that identifies the job), a job location, a job employer, a job start time indicator (e.g., a timestamp of when the job started or when the job applicant clocked in), a job end time indicator (e.g., a timestamp of when the job ended or when the job applicant clocked out), a job length (e.g., which can be the time difference between the job start and end time indicators), a job date, a job supervisor or manager, an employer reference for the job, a job rating, etc. The job information included in the third party reporting message can also include personal information, such as that which is discussed above. Also, the job information included in the third party reporting message can include employer information, such as an employer name, an employer tax identifier, an employer address, etc. Once the third party reporting message is generated, the method 300 continues to step 355.

In step 355, the one or more third party reporting messages are made available so that one or more third parties are able to access the third party reporting messages. In at least some embodiments, this includes sending the one or more third party reporting messages to one or more third party devices. In one embodiment, at least one of the third party reporting messages is sent directly (i.e., without first going to the backend application server facility 20) from the job applicant device 12 to the third party device. Additionally or alternatively, at least one of the third party messages is sent from the job applicant device 12 to the backend application server facility 20 and then from the backend application server facility 20 to the third party device, such as the at least one third party server 42. It should be appreciated that the third party reporting message sent from the job applicant device 12 does not need to include all of the same information or be formatted in the same manner as the third party reporting message received by the third party device, although it includes at least some of the job information. In another embodiment, the third party reporting messages are saved at the backend application server facility 20 in a manner such that the third party can access the third party reporting messages or the contents thereof. For example, in one embodiment, a third party reporting message is saved in one or more of the databases 24 and at least some or part of the information stored therein is made available to a third party via an account held by the third party with the application operating entity, which is the entity that makes, manages, or controls the employer application and the job applicant application. In many embodiments, the third party is separate and distinct from the application operating entity. In another embodiment, one or more of the third party reporting messages are sent from the job applicant device to the third party device via a text message, such as an SMS or MMS message, or via email. Also, either additionally or alternatively, one or more of the third party reporting messages are sent to the third party devices via a cloud service. The method 300 then ends.

In one embodiment, in step 315, the job applicant searches for a job being offered by an employer using an augmented reality view of the job applicant device. As used herein, an augmented reality view is a visual view that includes live images (i.e., images captured by the camera of the job applicant device that are streamed instantaneously to the visual display) as well as computer graphics that are laid over at least part of the live images. For example, a job applicant can enter an augmented reality job searching view that displays an augmented reality view on the visual display 130 of the job applicant device 12. The augmented reality view can include live images captured from the rear-facing camera 122 of the job applicant device 12. The augmented reality view can also render graphics within the live images (or displayed over the live images) in locations that correspond to the direction in which the job listing or posting location is relative to the job applicant device 12. For example, when there is a job listing that is posted having a location that is northwest relative to the job applicant device's current position, then, in the augmented reality view, a graphic identifying the job posting can be rendered when the rear-facing camera 122 has a field of view to the northwest of the job applicant device 12. Those skilled in the art will appreciate the various augmented reality techniques that can he applied, including those particular augmented reality techniques that are applied to a mobile device, such as a smartphone.

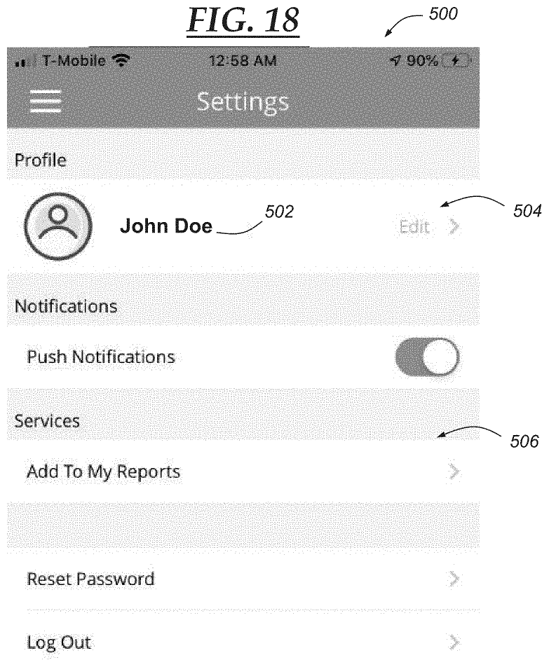

With reference to FIG. 18, there is shown a job applicant settings screen 500 that includes a job applicant name 502, a job applicant profile edit button 504, a third party reports configuration button 506, and other settings, such as a log out button, a reset password button, and a push notifications button. When the job applicant selects the applicant profile edit button 504, the GUI of the job applicant application 14 then displays a screen that enables the job applicant to edit their profile or other information, such as that which is discussed above in step 305. When the job applicant selects the third party reports configuration button 506, the job applicant can then be brought to the third party reporting screen 480, the send third party reports screen 490, or to a screen allowing the job applicant to configure third party reporting settings and/or to add/delete third parties (or third party reporting messages).

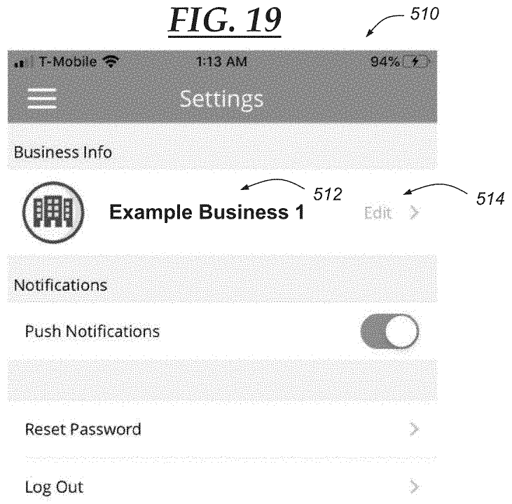

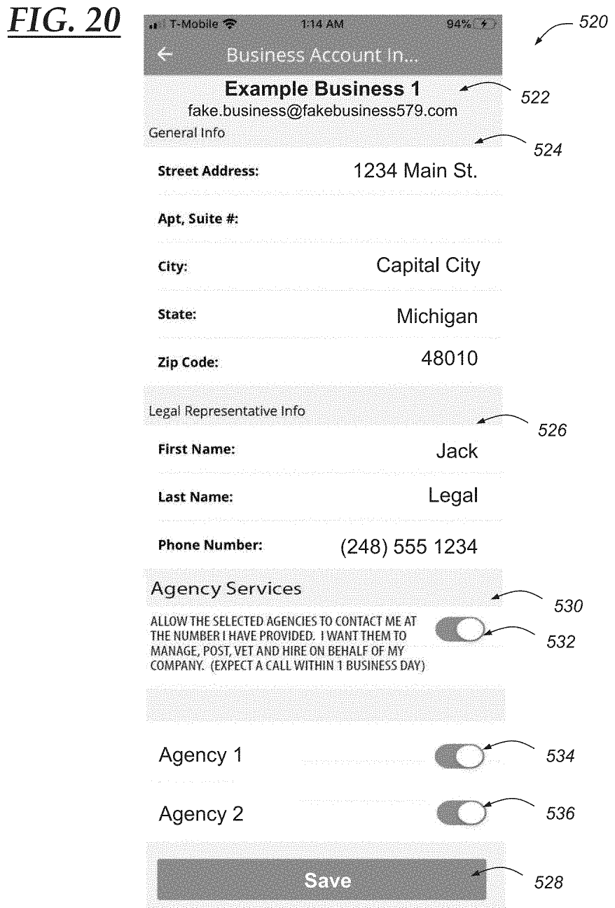

With reference to FIG. 19, there is shown an employer settings screen 510 that includes an employer (or business) name 512, an edit employer (or business) button 514, and other settings, such as a log out button, a reset password button, and a push notifications button. When the employer selects the edit employer (or business) button 514, the GUI of the employer application 18 then displays a screen that enables the employer to edit their profile (or one of their businesses' profiles) or other information. For example, when the employer selects the edit employer (or business) button 514, the GUI of the employer application 18 then displays the edit employer (or business) screen 520 as shown in FIG. 20. The edit employer (or business) screen 520 displays the employer (or business) name an email as indicated at 522, as well as general information (e.g., a business address) about the employer (as indicated at 524) or business and legal representative information (as indicated at 526). The edit employer (or business) screen 520 also includes a save button 528 so that any changes made by the employer can be saved to memory, such as to the memory 204 of the employer device 16.

The edit employer (or business) screen 520 can include employer agency services settings 530. The employer agency services settings 530 can include an enable button 532 that enables the employer agency services feature to be enabled or disabled. When enabled, the employer can specify one or more employer agencies (e.g., an office staffing company) to work with, such as “Agency 1” or “Agency 2”. The agencies can be granted access to the employer's account (or at least authorized to perform certain functions (e.g., post job listing, hire individuals)) on behalf of the employer. The agency can have an application (e.g., which can be similar to or the same as the employer application) that enables the agency to post job listings or carry out other tasks for the employer. In at least some embodiments, the agent of the employer agency is considered to use the employer application.

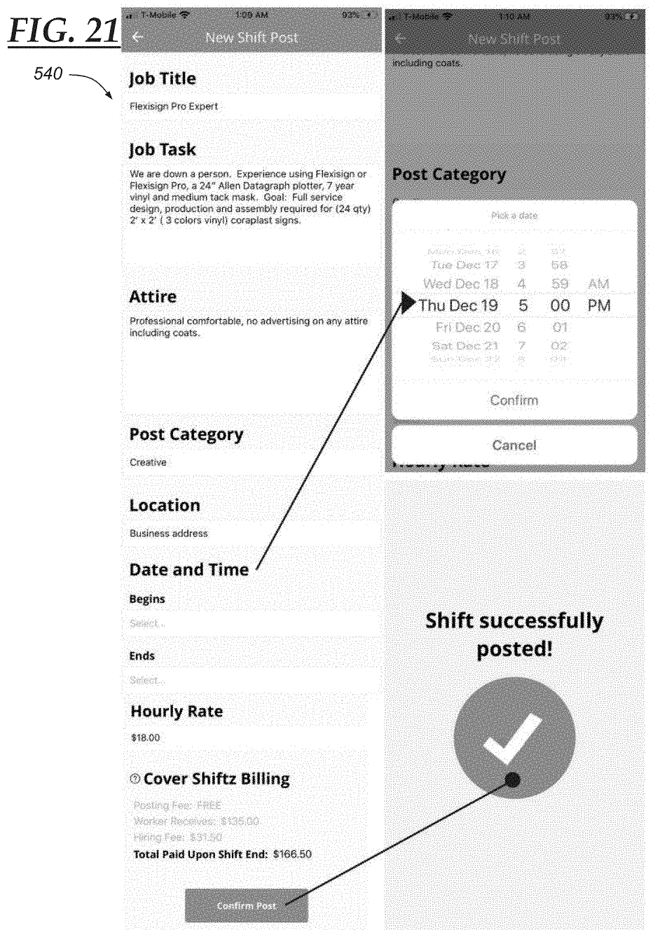

With reference to FIG. 21, there is shown a create job posting screen 540 that enables an employer (e.g., the actual employer or employee thereof or an agent of the employer, such as an individual of an employer agency (e.g., an office staffing company)) to create a job posting. The create job posting screen 540 enables a user to input a job title, a job task description, any required or suggested attire, a job category, a job location, a job date and time, a job hourly rate (or other job compensation), and a post job button (e.g., “Confirm Post”).

According to some embodiments, each third party report may gather unique information based on the requirement of that third party or of a program that the job applicant is participating in. The third party report is generated and saved at the job applicant device and/or the third party device. According to some embodiments, the job applicant controls if and how the third party report is distributed to any, each, or all third parties. The third party report can be sent to the third party via an API (e.g., a third party API (i.e., an API hosted by the third party, such as that which may be at the third party servers 42)), backend application server system (or other computer system used in connection with the job applicant application) to a third party computer system, web application or mobile application log-in, or otherwise from the job applicant application (or backend application servers 22) to a third party device without the job applicant ever having to log-into the third party's system. The third parties (to whom the reports are sent) may use a third party device (which can be a computer, cellphone, google glass, implanted chip technology, watches that mimic the abilities of a cellphone, in-car computer system, or other suitable communication hardware) to connect directly and/or indirectly to the third party servers 42, the backend application servers 22, and/or other device of the system/platform/web/app. The third party device can be used to securely (e.g., using security credentials) locate the specific job applicant history based on the job applicant's personal identifiers (e.g., eye scan, thumbprint, DNA information, signature, blood type, birth date, driver's license information including ID, state ID, case ID#, troop number, hiring agency credentials, union number, prisoner number, name), location, agency, social security, and/or case ID#.

In some embodiments, after or during the performance of a job, the employer can rate the performance (or their experience) (e.g., 5 starts, comments regarding their performance) with the job applicant using the employer application 18. Also, after or during the performance of a job, the job applicant can rate their experience (e.g., 5 starts, comments regarding their experience) with the employer using the job applicant application 14.

In one embodiment, after step 330, the job applicant device is sent a message from the employer device that indicates that the job applicant has a predetermined amount of time (e.g., 15 minutes) to accept the job and become hired by the employer. The job applicant application 14 can, for example, display a notification on the GUI of the job applicant device along with a confirm job hire button. When the job applicant selects the confirm job hire button within the predetermined amount of time, then a confirm job hire response message is sent from the job applicant device to the employer device, which can then notify or inform the employer that the job applicant has confirmed the hire.

Also, in some embodiments, the job applicant application 14 permits the job applicant to have a background performed on themselves by a third party background check service, which is an example of a third party. The job applicant application 14 can include a button, or other input, that, when selected, causes a message to be sent to a background check service. The message can include a job applicant identifier and other personal information concerning the job applicant, such as that information discussed above in step 305. The results of the background check can then be sent to the job applicant application 14. The job applicant can also use the job applicant application 14 to permit the employer, which may be a potential future employer, to access background check information, which is information obtained as a result of a background check performed by a third party background check service.

It is to be understood that the foregoing description is of one or more embodiments of the invention. The invention is not limited to the particular embodiments disclosed herein, but rather is defined solely by the claims below. Furthermore, the statements contained in the foregoing description relate to the disclosed embodiments and are not to be construed as limitations on the scope of the invention or on the definition of terms used in the claims, except where a term or phrase is expressly defined above. Various other embodiments and various changes and modifications to the disclosed embodiments will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of reporting job information concerning a job carried out by a job applicant for an employer to a third party, wherein the method comprises the steps of:
displaying a map view of a job applicant application on a visual display of a job applicant device of a job applicant, wherein the map view includes one or more map images, a job applicant icon, and at least one available job icon, and wherein the job applicant icon and the at least one available job icon are displayed over at least one of the one or more map images;
receiving input indicating that the job applicant desires to be hired for a job;
sending a job request message from the job applicant device to an employer device of an employer, wherein the job request message specifies job applicant information, and wherein the job applicant information includes a name of the job applicant;
recording job performance information concerning the job, wherein the job performance information includes a job length that specifies an amount of time that the job applicant took to perform the job; and
permitting one or more third parties to obtain one or more third party reporting messages through use of one or more third party devices, wherein each of the one or more third party reporting messages includes the job performance information and a job applicant identifier.

2. The method of claim 1, wherein the job applicant application enables the job applicant to select the one or more third parties, and wherein each of the one or more third party reporting messages are sent to one of the selected third parties.

3. The method of claim 1, wherein at least one of the one or more third party reporting messages is automatically sent to one of the one or more third party devices in response to the job applicant device or the employer device receiving an indication that the job has been completed by the job applicant.

4. The method of claim 3, wherein the job applicant application enables the job applicant to specify at least one of the one or more third party reporting messages to be automatically sent to one of the one or more third party devices in response to the job applicant device or the employer device receiving an indication that the job has been completed by the job applicant.

5. The method of claim 1, wherein the method further comprises the steps of:
selecting, using the job applicant device, at least one of the one or more third party reporting messages to be sent to at least one of the one or more third party devices; and
receiving input at the job applicant device via a graphical button presented on a touchscreen of the job applicant device, wherein, in response to receiving the input at the job applicant device, the at least one selected third party reporting message is sent to the at least one third party device.

6. The method of claim 1, wherein at least one of the one or more third party devices is a third party server that is located at a third party facility, and wherein the third party is an individual or entity that is separate and distinct from the job applicant and the employer.

7. The method of claim 1, wherein the permitting step includes sending the one or more third party reporting messages to the one or more third party devices.

8. The method of claim 7, wherein the one or more third party reporting messages are sent from the job applicant device to the one or more third party devices.

9. The method of claim 7, wherein the one or more third party reporting messages are sent from the job applicant device to a server of a remote server system, wherein the one or more third parties are able to access information included in the one or more third party reporting messages through communication with the remote server system.

10. A method of reporting job information concerning a job carried out by a job applicant for an employer to a third party, wherein the method comprises the steps of:
receiving job applicant information at a job applicant device from a job applicant, wherein the job applicant information is provided by the job applicant using one or more human-machine interfaces of the job applicant device, and wherein the job applicant information includes a name of the job applicant;
displaying a map view of a job applicant application on a visual display of the job applicant device of the job applicant, wherein the map view includes one or more map images, a job applicant icon, and at least one available job icon, and wherein the job applicant icon and the at least one available job icon are displayed over at least one of the one or more map images;
sending a job request message from the job applicant device to an employer device of an employer, wherein the job request message specifies at least part of the job applicant information, and wherein the at least part of the job applicant information includes the name of the job applicant;
clocking the job applicant into the job using either or both of the job applicant device and the employer device;
clocking the job applicant out of the job using either or both of the job applicant device and the employer device;
recording job performance information concerning the job, wherein the job performance information includes a job length that specifies an amount of time that the job applicant took to perform the job;
in response to clocking the job applicant out of the job, displaying a send third party reports screen on the visual display of the job applicant device using the job applicant application, wherein the send third party reports screen includes a third party reports list that has one or more selectable entries, each of which specifies either or both of: (i) a third party to which a third party reporting message is to be sent or (ii) a third party reporting message that is to be sent to a third party;
during a time in which the job applicant application is displaying the send third party reports screen, receiving input from the job applicant;
based on selection of the one or more selectable entries, determining one or more selected third party reporting messages to be sent; and
in response to receiving the input from the job applicant, sending the one or more selected third party reporting messages to one or more third party devices, wherein each of the one or more selected third party reporting messages includes the job performance information and a job applicant identifier, and wherein the third party is an individual or entity that is separate and distinct from the job applicant and the employer.
